(19) United States
(12) Patent Application Publication
(10) Pub. No.: US 2026/0115878 A1
(43) Pub. Date: Apr. 30, 2026

(54) POWERED FASTENER DRIVER

(71) Applicant: MILWAUKEE ELECTRIC TOOL CORPORATION, Brookfield, WI (US)

(72) Inventors: Mitchell T. Neuhoff, Waukesha, WI (US); Mark C. Hughes, Waukesha, WI (US); Bradley S. Houskamp, Wauwatosa, WI (US); Ivan N. Zozulya, Waukesha, WI (US); Jacob N. Zimmerman, Pewaukee, WI (US)

(21) Appl. No.: 19/430,568

(22) Filed: Dec. 23, 2025

Related U.S. Application Data
(63) Continuation of application No. 18/654,105, filed on May 3, 2024, now Pat. No. 12,515,303.
(60) Provisional application No. 63/464,217, filed on May 5, 2023.

(51) Int. Cl. B25C 1/04; B25C 1/00

(52) U.S. Cl. CPC B25C 1/042; B25C 1/001; B25C 1/047

(57) ABSTRACT

A powered fastener driver includes a piston movable within the inner cylinder from a top-dead-center (TDC) position to a driven or bottom-dead-center (BDC) position. The piston has a diameter of less than 45 mm, and a stroke length of the piston between the TDC position and the BDC position measures greater than 60 mm and less than 90 mm.

### CROSS-REFERENCE TO RELATED APPLICATIONS

This application is a continuation of co-pending U.S. patent application Ser. No. 18/654,105 filed on May 3, 2024, which claims priority to U.S. Provisional Patent Application No. 63/464,217 filed on May 5, 2023, the entire contents of both of which are incorporated herein by reference.

### FIELD OF THE INVENTION

The present invention relates to powered fastener drivers.

### BACKGROUND OF THE INVENTION

Powered fastener drivers are used for driving fasteners (e.g., nails, tacks, staples, etc.) into a workpiece. Such fastener drivers typically include a magazine in which the fasteners are stored and a fastener delivery mechanism for individually transferring fasteners from the magazine to a fastener driving channel, where the fastener is impacted by a driver blade during a fastener driving operation.

### SUMMARY OF THE INVENTION

In some aspects, the techniques described herein relate to a powered fastener driver including: a housing; an inner cylinder within the housing; a piston movable within the inner cylinder from a top-dead-center (TDC) position to a driven or bottom-dead-center (BDC) position, the piston having a diameter of less than 45 mm, and a stroke length of the piston between the TDC position and the BDC position measuring greater than 60 mm and less than 90 mm; a driver blade attached to the piston for movement therewith along a driving axis from the TDC position toward the BDC position for driving a fastener into a workpiece, the driver blade including, a first end, a second end, and a plurality of drive teeth extending from one side between the first end and the second end; a lifter operable to move the piston and driver blade from the BDC position toward the TDC position, wherein the lifter includes a body and a plurality of drive pins supported upon the body, wherein each of the drive pins is configured to engage one of the drive teeth, and wherein the drive pins are positioned on the body along an imaginary circle coaxial with a rotational axis of the lifter and having a diameter of less than 40 mm; and a drive unit operably coupled to the lifter to provide torque thereto, causing the lifter to rotate.

In some aspects, the techniques described herein relate to a powered fastener driver including: a housing; an inner cylinder within the housing; a piston movable within the inner cylinder from a top-dead-center (TDC) position to a driven or bottom-dead-center (BDC) position, the piston having a circumferential groove, a diameter of less than 45 mm, and a stroke length of the piston between the TDC position and the BDC position measuring greater than 60 mm and less than 90 mm; a seal ring positioned within the circumferential groove and configured to engage an inner surface of the inner cylinder, the seal ring having a thickness of 2 mm to 5.5 mm; a driver blade attached to the piston for movement therewith along a driving axis from the TDC position toward the BDC position for driving a fastener into a workpiece, the driver blade including, a first end, a second end, and a plurality of drive teeth extending from one side between the first end and the second end; a lifter operable to move the piston and driver blade from the BDC position toward the TDC position, wherein the lifter includes a body and a plurality of drive pins supported upon the body, wherein each of the drive pins is configured to engage one of the drive teeth; and a drive unit operably coupled to the lifter to provide torque thereto, causing the lifter to rotate.

In some aspects, the techniques described herein relate to a powered fastener driver including: a housing; an inner cylinder within the housing; an outer storage chamber cylinder positioned within the housing and including pressurized gas in fluid communication with the inner cylinder, wherein the outer storage chamber cylinder includes a first end and a second end opposite the first end, and wherein the second end of the outer storage chamber cylinder is non-concentric with the first end of the outer storage chamber cylinder a piston movable within the inner cylinder from a top-dead-center (TDC) position to a driven or bottom-dead-center (BDC) position, the piston having a circumferential groove, a diameter of less than 45 mm, and a stroke length of the piston between the TDC position and the BDC position measuring greater than 60 mm and less than 90 mm; a seal ring positioned within the circumferential groove and configured to engage an inner surface of the inner cylinder; a driver blade attached to the piston for movement therewith along a driving axis from the TDC position toward the BDC position for driving a fastener into a workpiece, the driver blade including, a first end, a second end, and a plurality of teeth extending from one side between the first end and the second end; a lifter operable to move the piston and driver blade from the BDC position toward the TDC position, wherein the lifter includes a body and a plurality of drive pins supported upon the body, wherein each of the drive pins is configured to engage one of the drive teeth,; and a drive unit operably coupled to the lifter to provide torque thereto, causing the lifter to rotate; wherein the outer storage chamber cylinder defines a volume, wherein a first portion of the volume is defined on a first side of the driving axis and a second portion of the volume is defined on a second side of the driving axis, and wherein the second portion is greater than the first portion, and wherein the housing defines a head portion, a drive unit housing portion, and a handle portion that is spaced apart from the drive unit housing portion, and wherein the second portion of the volume is at least partially positioned between the drive unit housing portion and the handle portion.

Other features and aspects of the invention will become apparent by consideration of the following detailed description and accompanying drawings.

### BRIEF DESCRIPTION OF THE DRAWINGS

FIG. 1 is a perspective view of a gas spring-powered fastener driver in accordance with an embodiment of the invention.

FIG. 2 is a side view of the gas-spring powered fastener driver of FIG. 1.

FIG. 3 is another perspective view of a portion of the gas spring-powered fastener driver of FIG. 1, with a portion removed for clarity.

FIG. 4 is a cross-sectional view of the gas spring-powered fastener driver of FIG. 1 along the line 4--4 of FIG. 2.

FIG. 5 is a cross-sectional view of the gas spring-powered fastener driver of FIG. 1 along the line 5--5 of FIG. 1.

FIG. 6 is a perspective view of a piston of the gas spring-powered fastener driver of FIG. 1.

FIG. 7 is a cross-sectional view of the piston f FIG. 6 along the line 7--7 of FIG. 6.

FIG. 8 is a perspective view of a driver blade of the gas spring-powered fastener driver of FIG. 1.

FIG. 9 is a plan view of a driver blade of the gas spring-powered fastener driver of FIG. 1.

FIG. 10 is a side view of a driver blade of the gas spring-powered fastener driver of FIG. 1.

FIG. 11 is a plan view of a lifter mechanism and a latch actuator assembly of the gas spring-powered fastener driver of FIG. 1.

FIG. 12 is an exploded view of the lifter mechanism of FIG. 11.

FIG. 13 is a plan view of the lifter mechanism of FIG. 11 with a portion removed.

FIG. 14 is an exploded view of the latch actuator assembly of FIG. 11.

FIG. 15 is a plan view of the latch actuator assembly of FIG. 11.

FIG. 16 is a left side view of a fastener delivery mechanism of the fastener driver of FIG. 1.

FIG. 17 is a right side view of the fastener delivery mechanism of FIG. 16.

FIG. 18 is a perspective view of an advancer for the fastener delivery mechanism of FIG. 16.

FIG. 19 is a side plan view of the advancer of FIG. 16.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

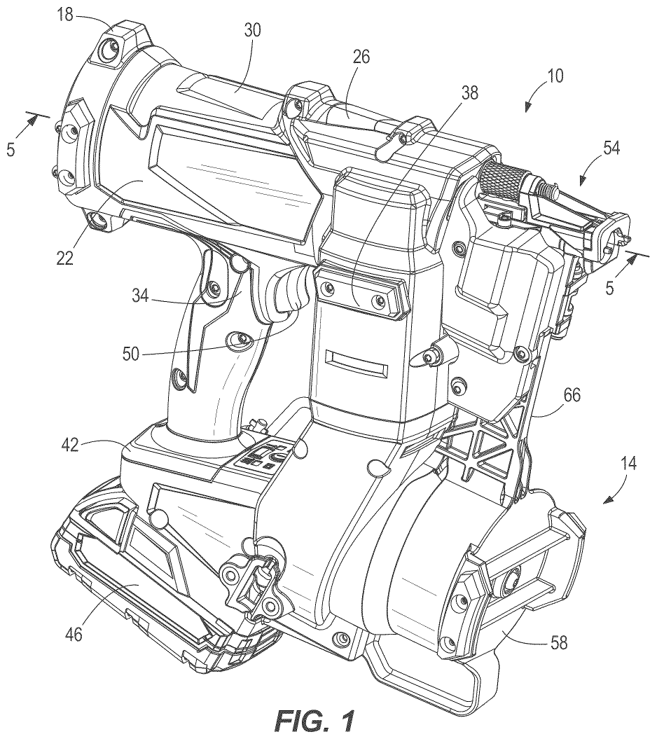

With reference to FIG. 1, a gas spring-powered fastener driver 10 is operable to drive fasteners (e.g., nails) held within a canister magazine 14 into a workpiece. The fastener driver 10 includes a housing 18 having a first housing shell 22 joined to a second housing shell 26. The housing 18 includes a head portion 30 having a handle portion 34 and a drive unit housing portion 38 extending therefrom. The housing 18 also includes a battery receptacle portion 42 that extends from the handle portion 34 and is sized and shaped to receive a removable battery pack 46. As shown, the fastener driver 10 further includes a trigger 50 that extends outwardly from the handle portion 34 of the housing 18. Further, the magazine 14 extends from a nosepiece 54 that is coupled to and extends from the housing 18.

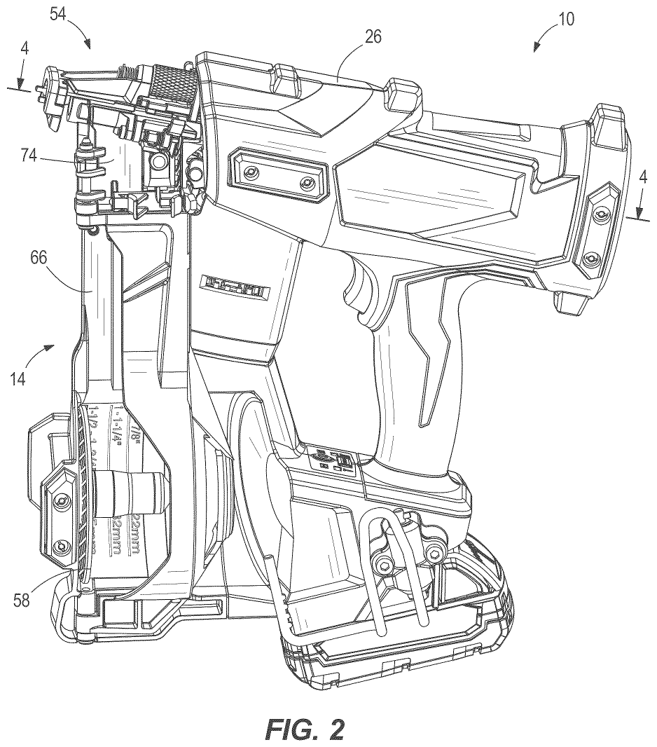

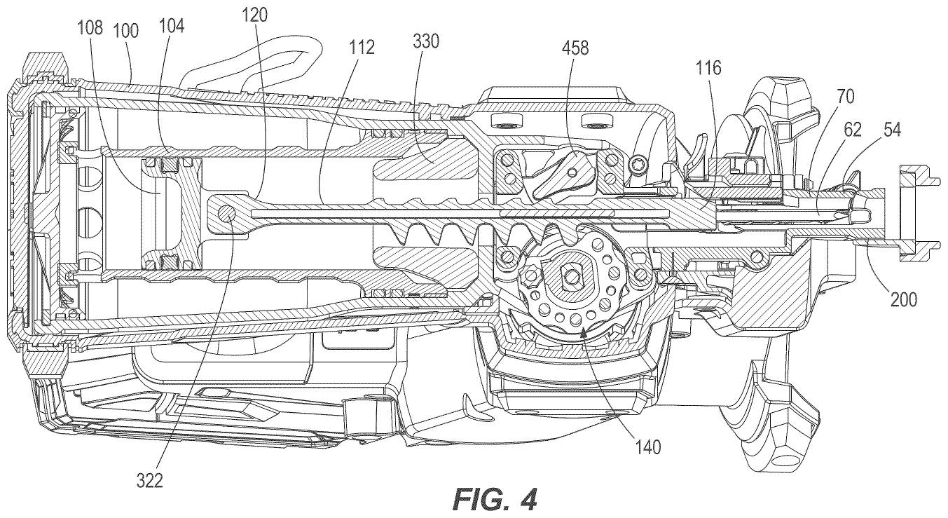

With reference to FIGS. 1 and 2, the magazine 14 includes a cannister portion 58 in which collated fasteners are arranged in a coil. The magazine 14 also includes a straight or linear portion 66 that is coupled to a nosepiece 54 of the fastener driver 10. The fasteners are sequentially transferred from the cannister portion 58, through the linear portion 66, and into a driver channel 70 (FIG. 4) within the nosepiece 54 by a fastener delivery mechanism 74.

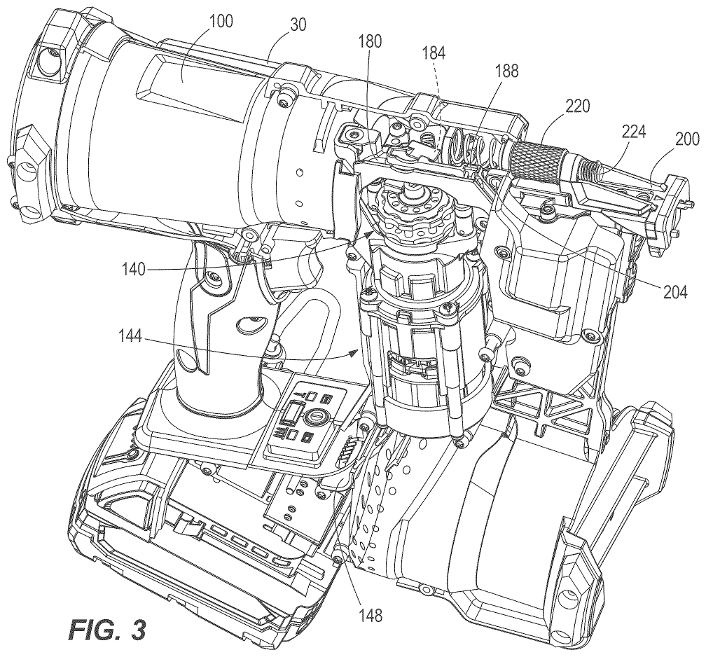

FIGS. 3-4 illustrate the internal components of the fastener driver 10. As shown, the fastener driver 10 includes a storage chamber cylinder 100 disposed within the head portion 30 of the housing 18. A driver cylinder 104 is positioned within the storage chamber cylinder 100, and a moveable piston 108 is positioned within the driver cylinder 104. The fastener driver 10 further includes a driver blade 112 that is attached to the piston 108 and moveable therewith. The driver blade 112 includes a first end 116 and a second end 120 opposite the first end 116. The first end 116 is a free end and the second end 120 is coupled to the piston 108.

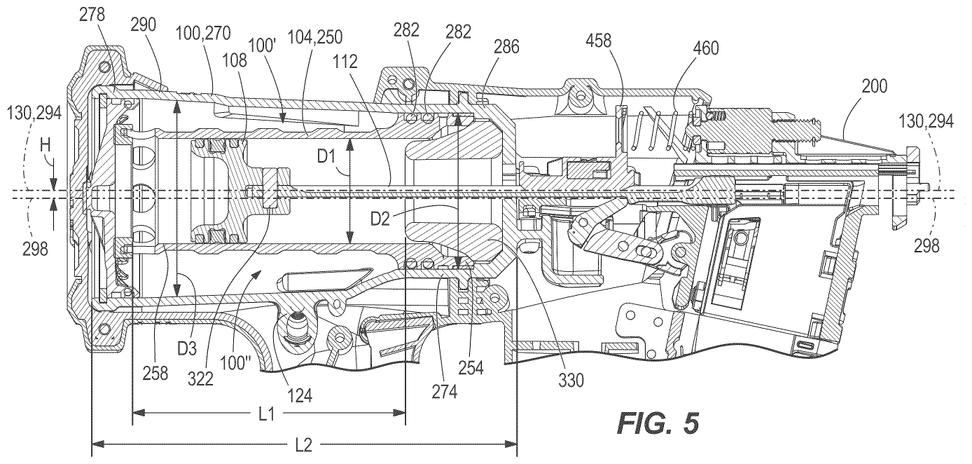

The fastener driver 10 does not require an external source of air pressure, but rather the storage chamber cylinder 100 includes pressurized gas in fluid communication with the driver cylinder 104. The driver 10 further includes a fill valve assembly 124 (FIG. 5) coupled to the storage chamber cylinder 100. When connected with a source of compressed gas, the fill valve assembly 124 permits the storage chamber cylinder 100 to be refilled with compressed gas if any prior leakage has occurred. The fill valve assembly 124 may be configured as a Schrader valve, a Presta valve, a Dunlop valve, or some other similar valve.

The piston 108, the driver cylinder 104, the storage chamber cylinder 100 collectively operate as a drive mechanism for driving the driver blade 112. In other embodiments, the drive mechanism can include a pneumatic drive mechanism powered by pressurized air from an external source, e.g., an air compressor or tank. Further, the drive mechanism may be powered by a flywheel, another mechanical device, or another source.

With reference to FIG. 5, the driver cylinder 104 and the driver blade 112 define a driving axis 130. During a driving cycle the driver blade 112 and the piston 108 are moveable between a top-dead-center (“TDC”) (i.e., retracted or ready) position and a bottom-dead-center (“BDC”) (i.e., extended or driven) position. In the illustrated embodiment, a stroke length L1 of the driver blade 112 between the TDC and the BDC positions measures approximately 70 mm (e.g., 2.8 inches), which is less than conventional drivers. In some embodiments, the stroke length may measure between less than approximately 65 mm (e.g., 2.5 inches) and greater than approximately 90 mm (e.g., 3.5 inches). For example, in some embodiments, the stroke length may measure between 60 mm and 90 mm. In other embodiments, the stroke length L1 may measure between approximately 67 mm (e.g., 2.6 inches) and approximately 85 mm (e.g., 3.3 inches). In some embodiments, the stroke length L1 is approximately 73 mm or less. The term approximately as used herein means plus or minus 5% of the stated value. The reduced stroke length L1 is achievable for various as reasons, as discussed in greater detail below. As shown in FIG. 3, the fastener driver 10 further includes a lifting mechanism 140, which is powered by a motor 144, and which is operable to move the driver blade 112 from the BDC position toward the TDC position.

Also, the fastener driver 10 includes a circuit board 148 (FIG. 3) that controls the operation of the fastener driver 10. The circuit board 148 is electrically connected to the battery receptacle portion 42 and the battery pack 46 when engaged therewith and provides DC power to the motor 144 (e.g., a brushless direct current (BLDC) motor).

In operation, the lifting mechanism 140 drives the piston 108 and the driver blade 112 toward the TDC position along the driving axis 130 by energizing the motor 144. As the piston 108 and the driver blade 112 are driven toward the TDC position, the gas above the piston 108 and the gas within the storage chamber cylinder 100 is compressed. Just prior to reaching the TDC position, the motor 144 is deactivated, stopping the piston 108 and the driver blade 112 in a “ready” position where the piston 108 and driver blade 112 are held until released by user activation of the trigger 50. The first end of the driver blade 112 is located adjacent the nosepiece 54 when the piston 108 is moved to a top dead center (TDC) (i.e., retracted or ready) position within the driver cylinder 104 and the fastener driver 10 is ready to be fired. When released, the compressed gas above the piston 108 and within the storage chamber cylinder 100 drives the piston 108 and the driver blade 112 to the BDC position along the driving axis 130, thereby driving a fastener 62 into a workpiece. Upon firing, the first end 116 of the driver blade 112 is moved into the nosepiece 54 to drive the fastener 62 from within the driver channel 70 of the nosepiece 54 and into a workpiece until the piston 108 reaches a bottom dead center (BDC) (i.e., extended or driven) position within the driver cylinder 104. The illustrated fastener driver 10 therefore operates on a gas spring principle utilizing the lifting mechanism 140 and the piston 108 to compress the gas within the driver cylinder 104 and the storage chamber cylinder 100 in preparation for a fastener driving cycle.

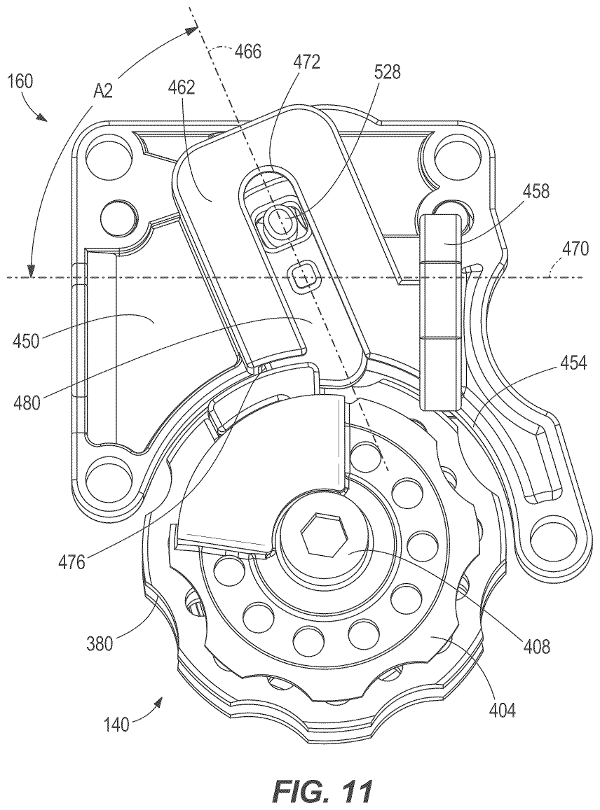

Moreover, as described in greater detail below, a latch actuator assembly 160 (FIG. 11) cooperates with the lifting mechanism 140 to selectively engage the driver blade 112 and hold the driver blade 112 in the ready position before the latch actuator assembly 160 is actuated by the lifting mechanism 140 to release the driver blade 112 into the nosepiece 54 to drive a fastener from the fastener driver 10 and into a workpiece.

As depicted in FIG. 3, the fastener driver 10 further includes a sensor bracket 180 disposed at least partially above the lifting mechanism 140. The sensor bracket 180 includes a first sensor 184 configured to sense an angular (or rotational) position of the lifting mechanism 140 and a second sensor 188 to sense a linear position of a workpiece contact bracket 200 that is slidably disposed on the nosepiece 54. For example, the sensors 184, 188 are Hall effect sensors that are configured to sense magnets or the presence of magnetic fields. The workpiece contact bracket 200 includes a magnet 204 that is sensed by the second sensor 188 when the workpiece contact bracket 200 is engaged with a workpiece and slides on the nosepiece 54. When the magnet 204 is sensed, the fastener driver 10 is allowed to fire.

As shown in FIG. 3, the fastener driver 10 includes a depth adjuster 220 having a threaded shaft 224 that is threadably engaged with the workpiece contact bracket 200. The depth adjuster 220 is rotatable to change a linear position of the workpiece contact bracket 200 relative to the nosepiece 54. This changes the depth to which a fastener expelled from the fastener driver 10 is driven into a workpiece.

With reference to FIG. 5, the driver cylinder 104 has an annular inner wall 250 configured to guide the piston 108 and driver blade 112 along the driving axis 130 to compress the gas in the storage chamber cylinder 100. The annular inner wall 250 includes a first end 254 and a second end 258 opposite the first end 254. The annular inner wall 250 has a first inner diameter D1 that is generally constant between the first end 254 and the second end 258. The first diameter D1 may measure between approximately 33 mm to approximately 45 mm. In the illustrated embodiment the first diameter measures approximately 37 mm.

With continued reference to FIG. 5, the storage chamber cylinder 100 has an annular outer wall 270 circumferentially surrounding the inner wall 250. More specifically, the storage chamber cylinder 100 extends from a first end 274 to a second end 278. Each of the illustrated first and second ends 274, 278 of the storage chamber cylinder 100, respectively, are circular. The first end 254 of the driver cylinder 104 is affixed to the first end 274 of the storage chamber cylinder 100. The first ends 254, 274 may be affixed in any suitable manner (e.g., press-fit engagement, threaded engagement, etc.). A seal 282 is disposed between the first end 254 of the driver cylinder 104 and the first end 274 of the storage chamber cylinder 100. The seal 282 prevents pressurized gas from escaping between the storage chamber cylinder 100 and the driver cylinder 104.

The storage chamber cylinder 100 includes a first portion 286 and a second, portion 290 adjacent the first portion 286. The first portion 286 is adjacent the first end 274, and has a second inner diameter D2 that is generally constant. The first portion 286 defines a first longitudinal axis 294 that is co-linear with the driving axis 130. The second portion 290 is adjacent the second end 278. The second portion 290 extends from the first portion 286 toward the second end 278. The second end 278 has a third inner diameter D3 that is variable along a length of the second portion 290 between the first portion 286 and the second end 278. As shown, the third diameter D3 generally increases from the first portion 286 to the second end 278. The second portion 290 defines a second longitudinal axis 298 coaxial with the second end 278. In other words, the second end 278 defines the second longitudinal axis 298 that extends through a center of the second end 278. The second longitudinal axis 298 extends parallel to and spaced from the driving axis 130 (e.g., the second longitudinal axis 298 is radially below the first longitudinal axis 294/driving axis 130 from the frame of reference of FIG. 5). As shown, in the illustrated embodiment, the second longitudinal axis 298 is generally closer to the handle portion 34 than the driving axis 130 and first longitudinal axis 294. The first and second longitudinal axes 294, 298, respectively, are offset. Accordingly, the storage chamber cylinder 100 is non-concentric with the driver cylinder 104. Moreover, as shown, the storage chamber cylinder 100 has a volume. A first portion 100′ of the volume is defined generally on a first side of the driving axis 130 and a second portion 100″ of the volume is defined generally on a second, opposite side of the driving axis 130. The second portion 100″ has a greater volume than the first portion 100′. The driver 10 further includes an end cap 302 positioned at the second end 278. The end cap 302 fluidly seals the driver cylinder 104 and the storage chamber cylinder 100 from the outside atmosphere.

The second longitudinal axis 298 is spaced from the first longitudinal axis 294 by an offset distance H. The offset distance H between the first longitudinal axis 294 and the second longitudinal axis 298 is between approximately 3% and approximately 25% of the third diameter D3 at the second end 278. In some embodiments, the offset distance His between approximately 3% and approximately 20% of the third diameter D3 at the second end 278. In further embodiments, the offset distance H is between approximately 3% and approximately 15% of the third diameter D3 at the second end 278. In yet further embodiments, the offset distance H is between approximately 3% and approximately 10% of third diameter D3 at the second end 278. In the illustrated embodiment, the offset distance H is approximately 3.5% of the third diameter D3 at the second end 278.

The non-concentric configuration of the driver cylinder 104 and the storage chamber cylinder 100 may reduce an overall size of the driver 10, and may facilitate positioning of the driver 10 in tight spaces during use of the driver 10. Specifically, an overall height of the driver 10 may be reduced as compared to conventional drivers. In addition, this configuration shifts the center of mass of the cylinders 104, 100 closer to the second end 278 where the handle portion 34 of the driver 10 is located (FIGS. 1-2), which may improve the balance and/or handling of the driver 10 while in use. Also, a length L2 of the storage chamber cylinder 100 may be less than the length of the storage chamber cylinders of conventional drivers. In the illustrated embodiment, the length L2 measures approximately 148 mm. In other embodiments, the length L2 of the storage chamber cylinder 100 between the first and second ends 274, 278 may range from approximately 125 mm to 180 mm. Additionally, the non-concentric configuration of the driver cylinder 104 and the storage chamber cylinder 100 is one of the factors that enables the stroke length L1 of the driver blade 112 to be reduced. This is because, despite the smaller footprint of the driver 10, the storage chamber cylinder 100 can still accommodate the necessary amount of gas. The amount of pressurized gas may range from approximately 134 cm³ to approximately 420 cm³. In the illustrated embodiments, the amount of pressurized gas may be approximately 270 cm³. Therefore, while the stroke length L1 is reduced and footprint of the driver is reduced, the large volume of the storage chamber cylinder 100 still enables a pressure of the pressurized gas to exert a striker force of 245 lbf at TDC in the illustrated embodiment. In other embodiments, while the stroke length L1 is reduced and footprint of the driver is reduced, the large volume of the storage chamber cylinder 100 still enables a pressure of the pressurized gas to exert a striker force of 100 lbf to 410 lbf at TDC. In other embodiments, while the stroke length L1 is reduced and footprint of the driver is reduced, the large volume of the storage chamber cylinder 100 still enables a pressure of the pressurized gas to exert a striker force of 200 lbf to 300 lbf on the piston 108 at TDC. In other embodiments, while the stroke length L1 is reduced and footprint of the driver is reduced, the large volume of the storage chamber cylinder 100 still enables a pressure of the pressurized gas to exert a striker force of greater than 200 lbf on the piston 108 at TDC. This allows for a favorable compression ratio of no more than approximately 1.38:1 in the illustrated embodiment. In some embodiments, the compression ratio may be up to approximately 1.6:1. Moreover, the low compression ratio reduces the lifting shear stress a lifter 380 of the lifting mechanism 140 experiences during operation.

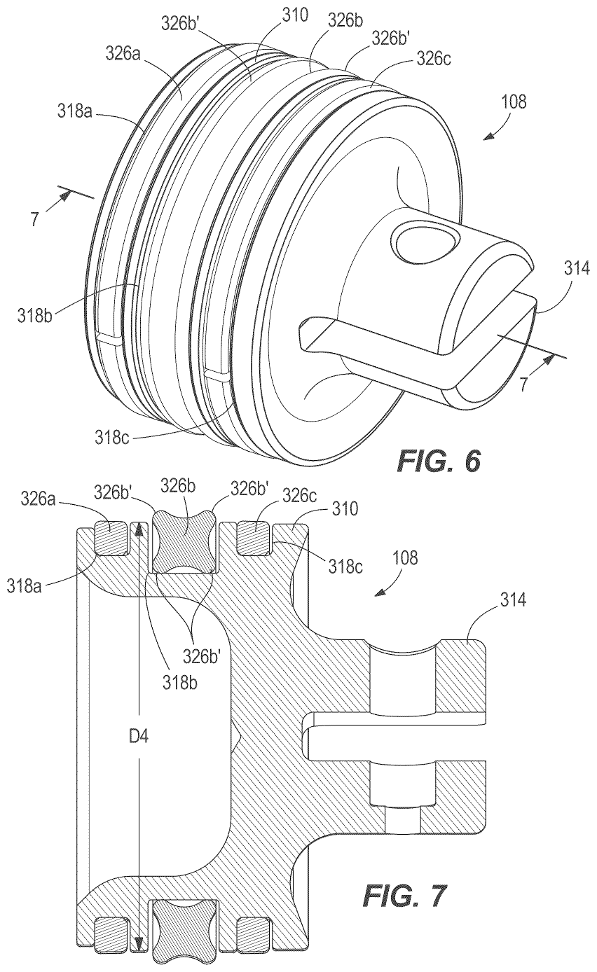

With respect to FIG. 6-7, in the illustrated embodiment, the piston 108 includes a first portion 310 and a second portion 314 that is integrally formed with or otherwise coupled to the first portion 310. The first portion 310 defines a plurality of groove 318a, 318b, 318c (e.g., circumferential grooves) that each extend about a circumference thereof. In the illustrated embodiment, the second groove 318b has a greater depth than the first and third grooves 318a, 318c. In the illustrated embodiment, the second portion 314 is integrally formed with the first portion 310. In some embodiments, the second portion 314 may be coupled to the first portion 310 via threaded engagement or via a fastener. The second portion 314 is coupled to the driver blade 112. In the illustrated embodiment, the driver blade 112 is coupled to the piston 108 via a fastener 322 (e.g., a pin, FIGS. 4 and 5), but in other embodiments, the driver blade 112 may be coupled to the piston in other ways (e.g., a threaded engagement).

In the illustrated embodiment, the piston 108 includes a smaller diameter compared to pistons in other gas spring-powered fastener drivers. The first portion 310 defines a maximum diameter D4 of the piston 108. A diameter of the second portion 314 is generally less than the diameter of the first portion 310, in the illustrated embodiment. Due to the reduced size of the piston 108 (e.g., the first portion 310 thereof), the pressure of the compressed gas necessary to move the piston 108 and driver blade 112 from the TDC position to the BDC position with sufficient force to adequately drive a nail into a workpiece increases.

The second groove 318b of the first portion 310 receives a seal ring 326b therein, which seals the piston 108 relative to the driver cylinder 104. As shown, the seal ring 326b is configured as a “quad ring.” When configured as a quad ring, the seal ring 326b includes a cross-sectional shape having four lobes 326b′, with adjacent lobes 326b′ being equidistantly spaced. In other embodiments, the seal ring 326b may be an O-ring having a conventional cylindrical cross-section. Regardless of whether the quad ring or the O-ring is used, the seal ring 326b is made from an elastomer or plastic material having a material composition to reduce friction with the inner wall of the driver cylinder 104 during sliding contact therewith. Each of the O-ring and the quad ring preferably have a thickness of between approximately 2 mm and 5.5 mm. Additionally, each of the first and third grooves 318a, 318c include a guide ring 326a, 326c, as well. In the illustrated embodiment, the guide rings 326a, 326c are O-rings.

In the illustrated embodiments, the maximum diameter D4 measures approximately 37 mm (e.g., 1.5 inches). Thus, a total surface area of the piston 108 is approximately 1075 mm². In other embodiments, the maximum diameter D4 of the piston 108 measures less than approximately 45 mm and a total surface area exposed to the compressed gas in the driver cylinder 104 of less than approximately 1590 mm². Additionally, the pressure of the compressed gas necessary to move the piston 108 and the driver blade 112 from the TDC position to the BDC position with sufficient force to adequately drive the nail into the workpiece is at least approximately 102 psi, which is greater than the pressure of conventional gas spring drivers when the piston is at the TDC position. The non-concentric configuration of the storage chamber cylinder 100 and the driver cylinder 104 as well as the smaller diameter D4 of the piston 108 enables sufficient pressure to drive the piston 108 despite the reduced size of the driver 10, as a whole. Additionally, the thickness of the seal ring 326b, as well as the use of the guide rings 326a, 326c helps to reduce permeation that results from the increased internal pressure. Also, the thickness of the seal ring 326b increases the compression of the seal to approximately 10%, which is at least twice as high as the seals used in conventional drivers.

With reference to FIGS. 4-5, the driver 10 includes a bumper 330 positioned beneath the piston 108 for stopping the piston 108 at the driven or BDC position and absorbing the impact energy from the piston 108. The bumper 330 is configured to distribute the impact force of the piston 108 uniformly throughout the bumper 330 as the piston 108 is rapidly decelerated upon reaching the BDC position. The bumper 330 may be formed from any suitable elastic material (e.g., rubber).

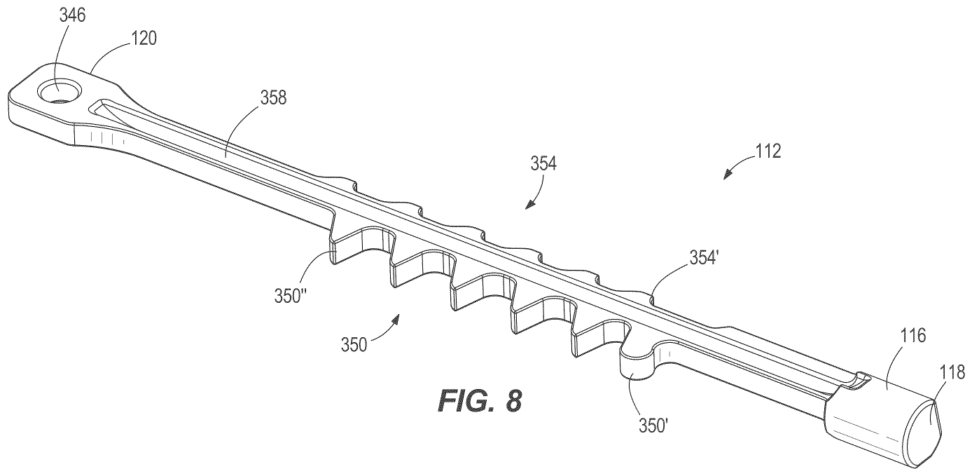

Referring to FIGS. 8-10, the details of the driver blade 112 are shown. As shown, the second end 120 includes a bore 346 that is sized and shaped to receive the pin 322 therethrough to attach the driver blade 112 to the piston 108. The driver blade 112 further includes a driver tip at the first end 116 of the driver blade 112. The driver tip is configured to strike and drive a fastener 62. The driver tip herein is generally cylindrical and defines a striking face 118 having a maximum dimension of 10 mm. In other embodiments, the maximum dimension of the striking face 118 may range from 5 mm to 15 mm.

The driver blade 112 includes a plurality of axially spaced drive teeth 350 on a first side of the driver blade 112 between the first end 116 and the second end 120 of the driver blade 112. As described in greater detail below, the drive teeth 350 are configured to engage the lifting mechanism 140 to move the driver blade 112 to the TDC (i.e., retracted or ready) position. The driver blade 112 also includes a plurality of axially spaced locking protrusions 354 on a second side of the driver blade 112, opposite the first side of the driver blade 112 and opposite the teeth 350, between the first end 116 and the second end 120 of the driver blade 112. As described in greater detail below, the locking protrusions 354 are configured to engage the latch actuator assembly 160 to hold the driver blade 112 in the TDC (i.e., retracted or ready) position prior to being released to the BDC (i.e., extended or driven) position. The driver blade 112 includes a guide groove 358 formed along the length of the driver blade 112 from the first end 116 to the second end 120. FIG. 10 further shows that the driver blade 112 includes an actuator tooth 362 extending from the driver blade 112 in a direction perpendicular to the drive teeth 350. The actuator tooth 362 actuates the fastener delivery mechanism 74 and loads a fastener into the nosepiece 54 as the driver blade 112 is returned to the TDC (i.e., retracted or ready) position after the fastener driver 10 is fired, as described in detail below.

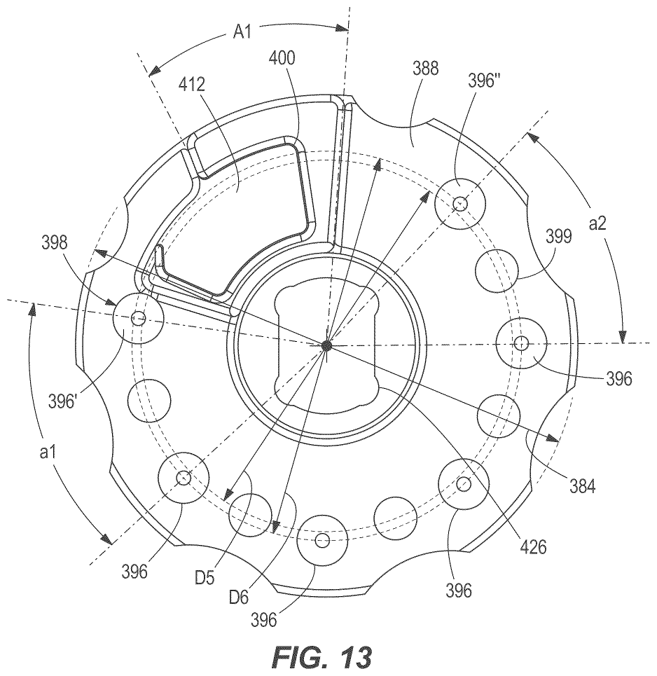

FIGS. 11-13 depict the details of the lifting mechanism 140. As shown, the lifting mechanism 140 includes a lifter 380 having a body and a plurality of drive pins 396 supported upon the body. The body includes a central hub 384 with an upper disk 388 and a lower disk 392 extending radially outward from the central hub 384 and spaced axially apart from each other. The plurality of drive pins 396 is installed within the lifter 380. Each drive pin 396 is coupled to both the upper disk 388 and the lower disk 392. The drive pins 396 include a drive pin 396′ that is configured to engage a drive tooth 350′ that is closest to the first end 116 of the driver blade 112 (e.g., the lowermost drive tooth) in the ready position. With respect to FIG. 13, the drive pin 396′ is oriented along an imaginary circle that is coaxial with the rotational axis of the lifter 380 and that has a fifth diameter D5, which in this case measures approximately 26.62 mm. In other embodiments, the fifth diameter D5 may be range from approximately 18 mm to 40 mm. The remaining drive pins 396 are oriented along an imaginary circle that is coaxial with the rotational axis of the lifter 380 and that has a sixth diameter D6, which is greater than the fifth diameter D5. In this case the sixth diameter measures approximately of 28.25 mm. In other embodiments, the fifth diameter D6 may be range from approximately 18 mm to 40 mm. Due to the reduced stroke length L1, the diameters D5 and D6 of the lifter 380 are also reduced relative to the lifters of conventional drivers. In the illustrated embodiment, there are six drive pins 396, each corresponding to an aperture 398 in the lifter 380. Additionally, there are apertures 390 positioned between adjacent drive pins 396. In the illustrated embodiment, there are five apertures 390. In other embodiments, there may more or fewer drive pins 396/apertures 398 and more or fewer apertures 399. In the illustrated embodiment, the drive pin 396′ is positioned at an angle a1 of approximately 51 degrees relative to the adjacent drive pin 396. Additionally, the remaining drive pins 396 are positioned at an angle a2 of approximately 46 degrees relative to the adjacent drive pins 396. In other embodiments, these angles a1 and a2 may range from approximately 40 degrees to approximately 60 degrees. Although the lifter 380 includes the body and the drive pins 396 in the illustrated embodiment, in other embodiments, the lifter 380 may be an integrally formed piece.

The lifter 380 further includes a cam 400 extending in an upward direction from the upper disk 388. As described in detail below, the cam 400 is configured to actuate the latch actuator assembly 160. In particular the cam 400 is configured to engage and actuate the latch actuator assembly 160 over an angle A1 (FIG. 13). In a particular aspect, the angle A1 ranges from approximately 20 degrees to approximately 45 degrees. In the illustrated embodiment, the angle A1 measures approximately 25.3 degrees. It is to be understood that the angle A1 may be within a range between, and including, any of the maximum and minimum values of A1 disclosed herein.

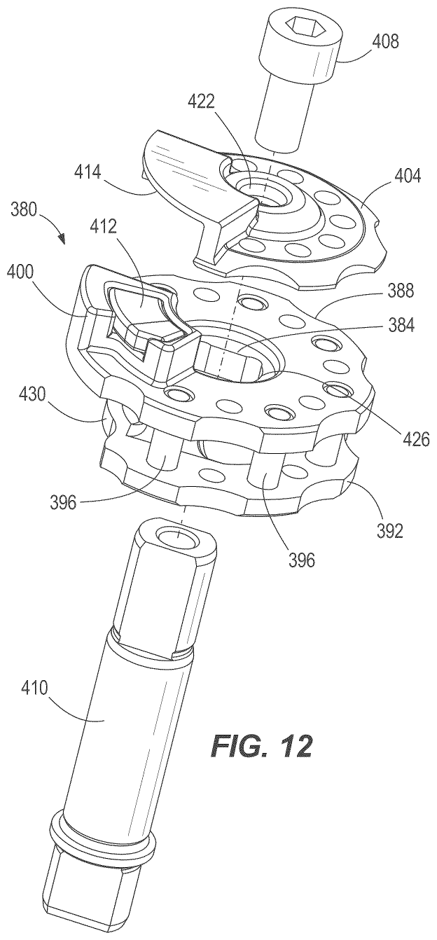

A magnet retainer 404 is disposed adjacent the upper disk 388 and a bolt 408 extends through the magnet retainer 404 secures the lifting mechanism 140 to a drive shaft 410 of the motor 144 (FIG. 3). Further, a magnet 412 is disposed within a pocket 414 the magnet retainer 404 and the magnet 412 is detected by the first sensor 184 (FIG. 3) that disposed within the sensor bracket 180 (FIG. 3) to control the operation of the motor 144 (FIG. 3) and the lifting mechanism 140 operably coupled thereto. Accordingly, when the magnet retainer 404 is installed on the lifter 380 as shown in FIG. 12, the magnet 412 is nested within the cam 400. The bolt 408 extends through a bore 422 in the magnet retainer 404 and a bore 426 in the lifter 380 and is threadably engaged with the drive shaft 410 that is keyed to the bore 426 in the lifter 380 to prevent the lifter 380 from rotating with respect to the motor shaft.

Referring back to FIG. 12, the lower disk 392 of the lifter 380 is formed with a peripheral notch 430 below the radial location of the cam 400 on the upper disk 388 of the lifter 380 such that the peripheral notch 430 overlaps the cam 400 in an axial direction. As described in detail below, the peripheral notch 430 provides clearance for the driver blade 112 when the fastener driver 10 is fired and the driver blade 112 is moved to the BDC (i.e., extended or driven) position into the nosepiece 54 to forcibly eject a fastener therefrom and into a workpiece.

FIGS. 11 and 14-15 show the details of the latch actuator assembly 160. As illustrated, the latch actuator assembly 160 includes base plate 450 that is formed with a semi-cylindrical notch 454 that is sized and shaped to fit around the lifting mechanism 140, e.g., around the lifter 380. A spring retainer 458 extends from an upper surface of the base plate 450 of the latch actuator assembly 160. The spring retainer 458 is configured to receive an end of a spring 460 (shown in FIG. 5) that is installed in compression between the spring retainer 458 of the latch actuator assembly 160 and the workpiece contact bracket 200 (FIG. 5) to bias the workpiece contact bracket 200 away from the spring retainer 458 along the nosepiece 54.

The latch actuator assembly 160 includes a generally rectangular shuttle housing 462 that is disposed on the upper surface of the base plate 450. It is to be understood that the shuttle housing 462 may be integrally formed with the base plate 450. As shown, the shuttle housing 462 includes a longitudinal axis 466 that is formed at an angle A2 with respect to a longitudinal axis 470 of the base plate 450. In a particular aspect, the angle A2 measures approximately 60 degrees to approximately 75 degrees. In the illustrated embodiment, the angle A2 is approximately 67 degrees. It is to be understood that the angle A2 may be within a range between, and including, any of the maximum and minimum values of A2 disclosed herein.

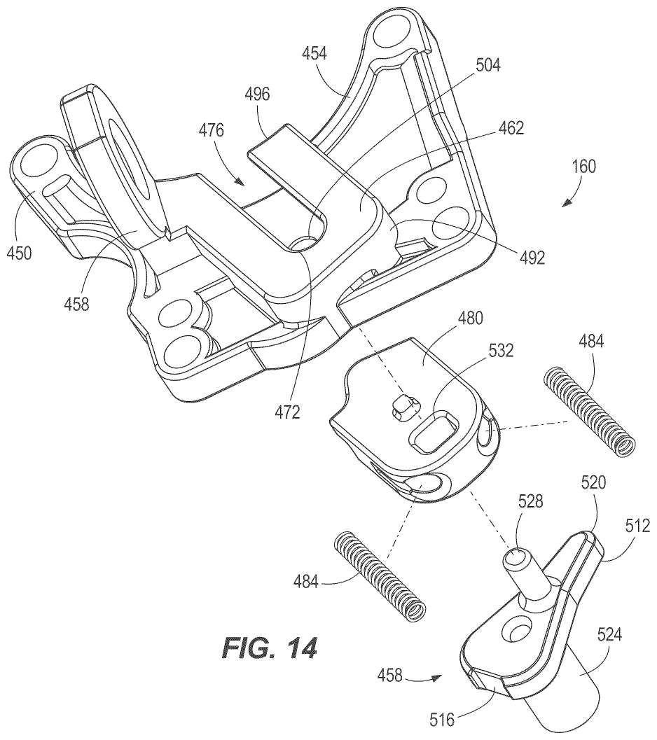

The shuttle housing 462 includes a slot 472 formed in an upper surface of the shuttle housing 462 at least partially along the length of the upper surface and along the longitudinal axis 466. The shuttle housing 462 also includes a pocket 476 that is sized and shaped to receive a shuttle 480 slidably, or otherwise movably, therein. As shown in FIG. 14, first shuttle spring 484 and a second shuttle spring 488 are disposed parallel to each other and parallel to the longitudinal axis 466 of the shuttle housing 462 in compression within the pocket 476 between a closed end 492 of the shuttle housing 462 (and the pocket 476) and the shuttle 480 to bias the shuttle 480 outward from the pocket 476 and an open end 496 of the shuttle housing 462 (and the pocket 476) so that a portion of the shuttle 480 extends into the semi-cylindrical notch 454.

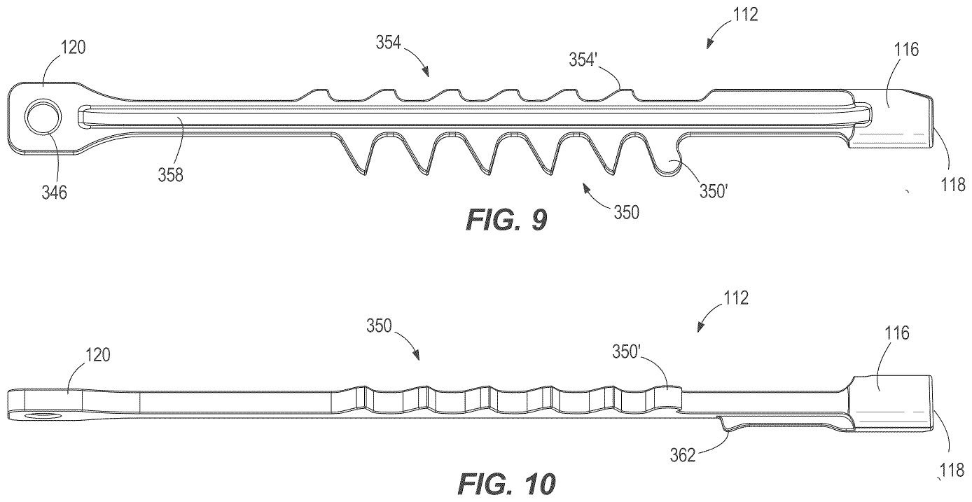

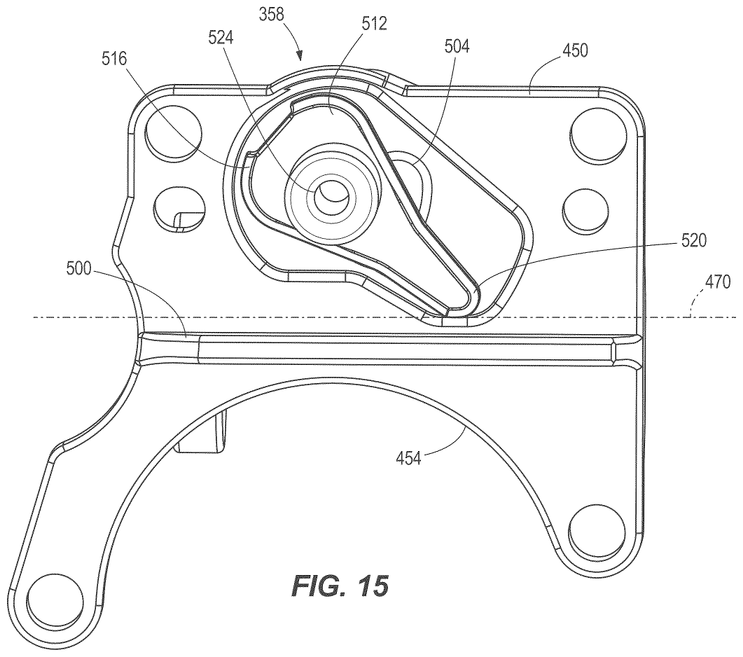

As shown in FIG. 15, the latch actuator assembly 160 further includes a guide rib 500 that extends perpendicularly from a lower surface of the base plate 450. The guide rib 500 extends along the entire length of the base plate 450 and is parallel to the longitudinal axis 470. The guide rib 500 is sized and shaped to fit into the guide groove 358 (FIGS. 8-9) of the driver blade 112 and acts as a guide for the driver blade 112 as it moves between the TDC (i.e., retracted or ready) position and the BDC (i.e., extended or driven) position.

FIGS. 14-15 further show that the base plate 450 is formed with a curved slot 504 that extends through the base plate 450, i.e., from the upper surface to the lower surface. A portion of a latch assembly 508 fits into the curved slot 504 and rotates therein as the shuttle 480 moves linearly within the shuttle housing 462. As shown in FIG. 14, the latch assembly 508 includes a latch 512 that includes a first end 516 and a second end 520. A support post 524 extends perpendicularly from a lower surface of the latch 512 in a first direction. An actuator post 528 extends perpendicularly from an upper surface in a second direction opposite the first direction and opposite the support post 524.

When the latch actuator assembly 160 is assembled, the actuator post 528 extends through the curved slot 504 and into a bore 532 formed in the shuttle 480. The support post 524 is configured to fit into and rotate within a bore (not shown) formed in the nosepiece 54. Accordingly, as the shuttle 480 moves linearly back-and-forth within the shuttle housing 462, the latch assembly 508 rotates about the support post 524 and the second end 520 of the latch 512 moves back-and-forth. As described in greater detail below, the lifting mechanism 140 rotates to actuate the latch actuator assembly 160.

The operation of the lifting mechanism 140 and the latch actuator assembly 160 to fire and reset the driver blade 112 is as follows. In the ready position, the motor 144 is de-energized and stationary. The drive pin 396′ is engaged with the lowermost drive tooth 350′. The cam 400 on the lifter 380 is adjacent and in contact with the end of shuttle 480 that is extending from the open end 496 of the shuttle housing 462. As shown, in the ready position, the magnet 412 within the magnet retainer 404 on the lifter 380 is in a position to be sensed by the first sensor 184 within the sensor bracket 180. Also, the second end 520 of the latch 512 is engaged with one of the locking protrusions 354 on the driver blade 112, e.g., the locking protrusion 354′ nearest the first end 116 of the driver blade 112. Accordingly, the latch 512 holds the driver blade 112 locked in the TDC (i.e., retracted or ready) position against the force of the gas spring (i.e., the compressed gas within the storage chamber cylinder 100).

When a user actuates the trigger 50 of the fastener driver 10, the motor 144 is energized and rotates counterclockwise from the perspective of FIGS. 5 and 11 and also rotates the lifter 380 of the lifting mechanism 140 counterclockwise. As the lifter 380 rotates, the cam 400 on the lifter 380 pushes the shuttle 480 into the shuttle housing 462 against the force of the springs 484, 488. As the shuttle 480 moves into the shuttle housing 462 it pushes the actuator post 528 along the curved slot 504 formed in the base plate 450 of the latch actuator assembly 160 and the latch assembly 508 rotates on the support post 524 within the bore 536 of the nosepiece 54. The second end 520 of the latch 512 rotates away from the driver blade 112 into a position in which the latch 512 disengages the locking protrusion 354 and remains clear of the locking protrusions 354.

As disclosed herein, as the lifter 380 rotates, the cam 400 remains in contact with the shuttle 480 over the angle A1 which is within a range between and including 20° to 45°. The shape of the cam 400 keeps the shuttle 480 toggle into the shuttle housing 462 which, in turn, keeps the second end 520 of the latch 512 rotated into a position away from the driver blade 112 and clear of the locking protrusions 354. As the lifter 380 continues to rotate counterclockwise into a firing position, the latch 512 remains clear of the locking protrusions 354, while the peripheral notch 430 on the lower disk 392 of the lifter 380 remain clear of the drive teeth 350. In the firing position, the drive pins 396 on the lifter 380 are clear of the drive teeth 350 on the driver blade 112. Accordingly, the driver blade 112 is released and the force of the compressed gas behind the piston 108 and within the storage chamber cylinder 100 drives the piston 108 and the driver blade 112 toward the BDC (i.e., extended or driven position), into the nosepiece 54 to expel a fastener from the fastener driver 10 and drive the faster into a workpiece.

After the driver blade 112 is released and fired by the compressed gas in the storage chamber cylinder 100, the motor 144 continues to rotate the lifting mechanism 140 counterclockwise. When the cam 400 rotates past the latch actuator assembly 160, the shuttle 480 is released and the springs 484, 488 bias the shuttle 480 toward the lifter 380 and the second end 520 of the latch 512 moves toward the driver blade into a position in which the latch 512 is able to engage one of the locking protrusions 354 if the motor 144 fails. As the lifter 380 rotates the drive pins 396 engage the drive teeth 350 on the driver blade 112 in sequence to move the driver blade 112 in a direction away from the nosepiece 54 and return the driver blade 112 to the TDC (i.e., retracted or ready) position. Specifically, one of the drive pins 396″ engages the uppermost drive tooth 350″ and the other drive pins 396 engage each respective tooth 350 in sequence. As the lifter 380 returns the driver blade 112 to the TDC (i.e., retracted or ready) position, the piston 108 compresses the gas within the storage chamber cylinder 100. Moreover, as the driver blade 112 returns to the TDC (i.e., retracted or ready) position, the locking protrusions 354 will rotate the latch 512 away from the driver blade 112 against the springs 484, 488 which return the latch 512 toward the driver blade 112 as each locking protrusion 354 passes. The motor 144 continues to rotate the lifting mechanism 140 counterclockwise until the driver blade 112 is returned to the TDC (i.e., retracted or ready) position and the magnet 412 on the lifter 380 is detected by the first sensor 184 in the sensor bracket 180 to signal the controller to de-energize the motor 144. The drive pin 396′ once again engages the lowermost drive tooth 350′ and the second end 520 of the latch 512 engages the locking protrusion 354′ nearest the first end 116 of the driver blade 112 to hold the driver blade 112 in the ready position until the trigger 50 is, once again, pressed by a user. It is to be understood that the illustrated fastener driver 10 operates on a gas spring principle utilizing the lifting mechanism 140 and the piston 108 to further compress the gas within the driver cylinder 104 and the storage chamber cylinder 100.

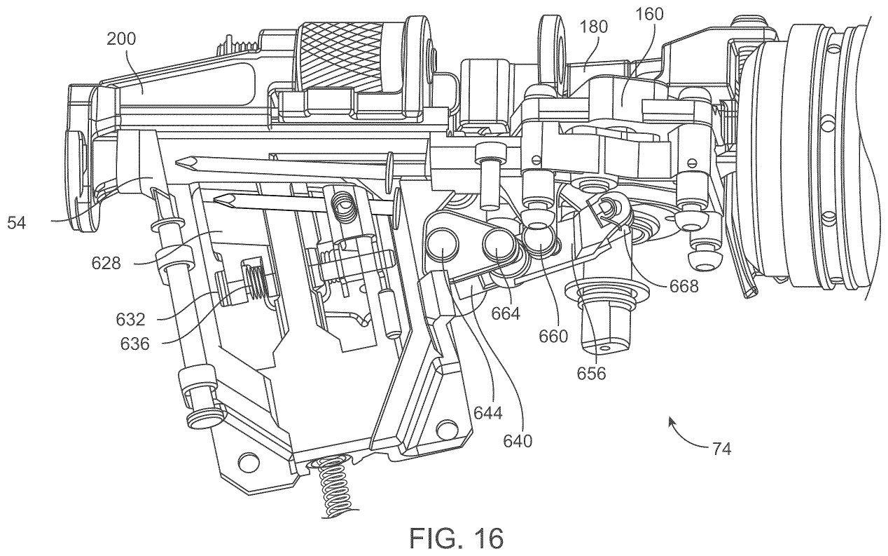

FIGS. 16-19 illustrate the details of the fastener delivery mechanism 74. As shown, the fastener delivery mechanism 74 includes a support post 604 that is slidably disposed within a bracket 608 on the nosepiece 54. The support post 604 includes a proximal end 612 and a distal end 616. A spring 620 is installed in compression adjacent the proximal end 612 of the support post 604 to bias the support post 604 toward a barrel 624 of the nosepiece 54. An advancer 628 is mounted on the distal end 616 of the support post 604 via a hinge pin 632. A torsional spring 636 is disposed on the hinge pin 632 to bias the advancer 628 around the hinge pin 632 toward the nosepiece 54.

The fastener delivery mechanism 74 further includes a first rocker arm 640 rotatably mounted on the nosepiece 54 via a first post 644 (e.g., a threaded fastener). The first rocker arm 640 includes a forked end 648 that fits around a lateral post 652 on the distal end of the support post 604. As shown, the fastener delivery mechanism 74 also includes a second rocker arm 656 rotatably mounted on the nosepiece 54 via a second post 660 and mounted to the first rocker arm 640 via a third post 664. A spring loaded actuator 668 is installed on a free end of the second rocker arm 656. The spring loaded actuator 668 may only rotate in a single direction toward the delivery end of the fastener driver 10 against the force of a spring which returns it to an upright position.

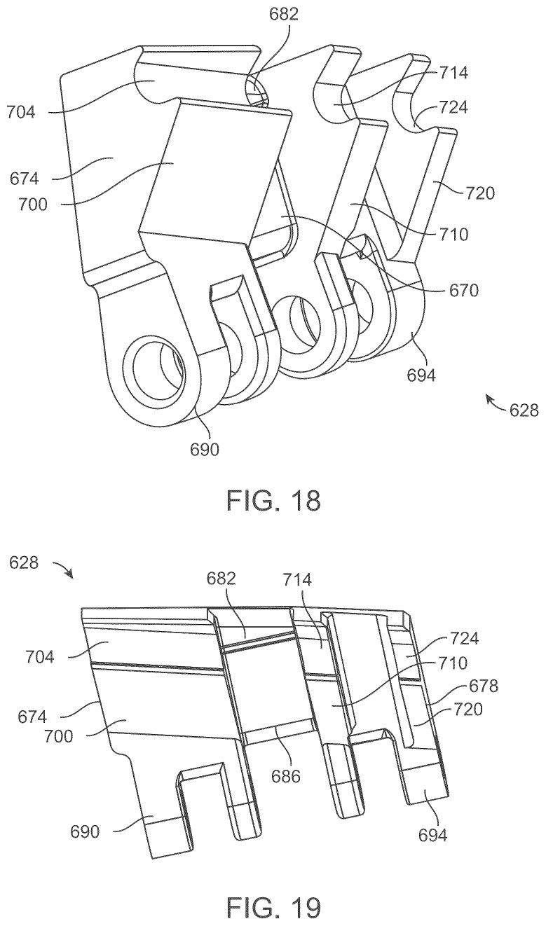

Referring to FIGS. 18 and 19, the advancer 628 is illustrated in greater detail. The advancer 628 includes a body 670 that includes a first end 674, a second end 678, a top 682, and a bottom 686. A first pair of hinge barrels 690 extend in a generally downward direction from the bottom 686 of the body 670 near the first end 674. A second pair of hinge barrels 694 extend in a generally downward direction from the bottom 686 of the body 670 near the second end 678. The pairs of hinge barrels 690, 694 are spaced apart from each other to form an opening that fits over the distal end 616 of the support post 604. The hinge pin 632 fits through both pairs of hinge barrels 690, 694 and a bore formed in the distal end 616 of the support post 604.

As shown, the advancer 628 includes a first ramped structure 700 that extends from the bottom 686 of the body 670 toward the top 682. The first ramped structure 700 is narrowest at the bottom 686 and widest at the top 682. The first ramped structure 700 terminates at a first groove 704 near the top 682 that is sized and shaped to receive a portion of a fastener therein. The advancer 628 includes a second ramped structure 710 that extends from the bottom 686 of the body 670 toward the top 682. The second ramped structure 710 is narrowest at the bottom 686 and widest at the top 682. The second ramped structure 710 terminates at a second groove 714 near the top 682 that is sized and shaped to receive a portion of a fastener therein. The advancer 628 further includes a third ramped structure 720 that extends from the bottom 686 of the body 670 toward the top 682. The third ramped structure 720 is narrowest at the bottom 686 and widest at the top 682. The third ramped structure 720 terminates at a third groove 724 near the top 682 that is sized and shaped to receive a portion of a fastener therein.

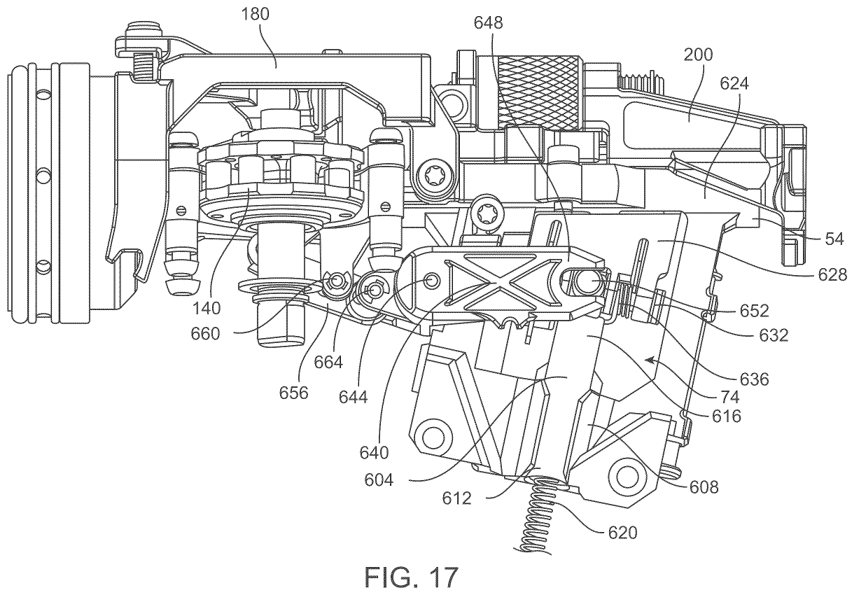

When the driver blade 112 is fired, or moved to the BDC (i.e., extended or driven) position, the actuator tooth 362 on the driver blade 112 moves past the spring loaded actuator 668, which rotates downward briefly before the spring force returns it to the upright position. As the driver blade 112 is returned to the TDC (i.e., retracted or ready) position by the lifting mechanism 140, as described herein, the actuator tooth 362 on the driver blade 112 engages the spring loaded actuator 668 to rotate the second rocker arm 656 counterclockwise in FIG. 17. This causes the first rocker arm 640 to rotate clockwise in FIG. 17 and move the support post 604 away from the barrel 624 the nosepiece 54. As the support post 604 moves away from the barrel 624, the ramped structures 700, 710, 720 on the advancer 628 move against a fastener to be loaded and rotate the advancer 628 outward from the fastener against the spring force provided by the torsional spring 636 until the grooves 704, 714, 724 are aligned with the fastener to be loaded. When the grooves 704, 714, 724 are aligned with the fastener, the torsional spring 636 biases the advancer 628 toward the nosepiece 54 so that the grooves 704, 714, 724 fit around the fastener. Then, the spring 620 biases the support post 604 in an upward direction toward the barrel 624 of the nosepiece 54 and loads the fastener that is held within the grooves 704, 714, 724 of the advancer 628 into the barrel 624 in a ready position to be expelled from the fastener driver 2000 and driven into a workpiece when the trigger 50 is actuated.

As noted above, the reduced stroke length L1 of the driver blade 112 enables a reduced size of the lifter 380. That is, the driver pins 396 are able to be oriented on imaginary circles having reduced diameters D5, D6. The reduced size of the lifter 380 allows operation of the motor 144 to be more efficient. That is, the reduced size of the lifter 380 reduces the required lifter torque and geartrain loading, while maintaining effectiveness of the fastener driver 10. Additionally, the reduced size of the lifter 380 and the reduced size of piston 108 decreases the size and weight of the fastener driver 10 while have the same or better power perfomance. In the illustrated embodiment, the lifter torque measures approximately 165 in-lbs. Additionally, the drive cycle of the fastener 10 is also shorter. Because the motor 144 is more efficient, the user is able to fire 4.3 nails per second, which is more nails per second than can be driven by conventional drivers. Accordingly, the driver blade 112 is configured to reciprocate between the TDC position and the BDC position at a frequency of at least approximately 2 Hertz (Hz). In other embodiments, the driver blade 112 is configured to reciprocate between the TDC position and the BDC position at a frequency of approximately 3.25 Hz. In other embodiments, the driver blade 112 is configured to reciprocate between the TDC position and the BDC position at a frequency of approximately 2 Hz to approximately 5 Hz. Moreover, the stroke length L1 of the piston 108 between the TDC position and the BDC position is approximately 70 mm or less while reciprocating at a frequency of at least 3.25 Hz. Moreover, the stroke length L1 of the piston 108 between the TDC position and the BDC position is approximately 65 mm or greater while reciprocating at a frequency of at least 3.25 Hz. Moreover, the stroke length L1 of the piston 108 between the TDC position and the BDC position is approximately 65 mm or greater while reciprocating at a frequency of at least 2 Hz. Also, because the motor 144 is more efficient, the driver 10 can drive more fasteners without thermal shutdown of the motor 144. That is, a temperature of the motor 144 may be measured (e.g., by a sensor) and monitored by the circuit board 148. When the temperature rises above a predetermined threshold temperature, the circuit board 148 will no longer allow the motor 144 to be driven, which results in thermal shutdown of the motor.

In the illustrated embodiments, the driver can drive at least 1560 nails without thermal shut down. In some embodiments, the driver can drive at least 480 nails without thermal shutdown. In some embodiments, the driver can drive at least 500 nails without thermal shutdown. In some embodiments, the driver can drive at least 700 nails thermal shutdown. In some embodiments, the driver can drive at least 800 nails thermal shutdown. In some embodiments, the driver can drive at least 900 nails thermal shutdown. In some embodiments, the driver can drive at least 1000 nails without thermal shutdown. In some embodiments, the driver can drive at least 1100 nails without thermal shutdown. In some embodiments, the driver can drive at least 1200 nails without thermal shutdown. In some embodiments, the driver can drive at least 1300 nails without thermal shutdown. In some embodiments, the driver can drive at least 1400 nails without thermal shutdown. In some embodiments, the driver can drive at least 1500 nails without thermal shutdown.

The drive unit is configured to remain continuously activated for over 100 seconds while reciprocating the driver blade at a frequency of at least 3.25 Hz. The drive unit is configured to remain continuously activated for over 100 seconds while reciprocating the driver blade at a frequency of at least 2 Hz. The drive unit may be configured to remain continuously activated for over 360 seconds while reciprocating the driver blade at a frequency of at least 3.25 Hz. The drive unit is configured to remain continuously activated for over 360 seconds while reciprocating the driver blade at a frequency of at least 2 Hz. The drive unit may be configured to remain continuously activated for 100 seconds to 360 seconds while reciprocating the driver blade at a frequency of at least 3.25 Hz. The drive unit may be configured to remain continuously activated for 100 seconds to 360 seconds while reciprocating the driver blade at a frequency of at least 2 Hz. The drive unit may be configured to remain continuously activated for 150 seconds to 360 seconds while reciprocating the driver blade at a frequency of at least 3.25 Hz. The drive unit may be configured to remain continuously activated for 150 seconds to 360 seconds while reciprocating the driver blade at a frequency of at least 2 Hz. The drive unit may be configured to remain continuously activated for 200 seconds to 360 seconds while reciprocating the driver blade at a frequency of at least 3.25 Hz. The drive unit may be configured to remain continuously activated for 200 seconds to 360 seconds while reciprocating the driver blade at a frequency of at least 2 Hz. The drive unit may be configured to remain continuously activated for 250 seconds to 360 seconds while reciprocating the driver blade at a frequency of at least 3.25 Hz. The drive unit may be configured to remain continuously activated for 250 seconds to 360 seconds while reciprocating the driver blade at a frequency of at least 2 Hz. The drive unit may be configured to remain continuously activated for 300 seconds to 360 seconds while reciprocating the driver blade at a frequency of at least 3.25 Hz. The drive unit may be configured to remain continuously activated for 300 seconds to 360 seconds while reciprocating the driver blade at a frequency of at least 2 Hz. The drive unit may be configured to remain continuously activated for 100 seconds to 200 seconds while reciprocating the driver blade at a frequency of at least 3.25 Hz. The drive unit may be configured to remain continuously activated for 100 seconds to 200 seconds while reciprocating the driver blade at a frequency of at least 2 Hz. The drive unit may be configured to remain continuously activated for 150 seconds to 300 seconds while reciprocating the driver blade at a frequency of at least 3.25 Hz. The drive unit may be configured to remain continuously activated for 150 seconds to 300 seconds while reciprocating the driver blade at a frequency of at least 2 Hz.

Although the invention has been described in detail with reference to certain preferred embodiments, variations and modifications exist within the scope and spirit of one or more independent aspects of the invention as described.

Various features of the invention are set forth in the following claims.

What is claimed is:

1. A powered fastener driver comprising:
a housing;
an inner cylinder within the housing;
a piston movable within the inner cylinder from a top-dead-center (TDC) position to a driven or bottom-dead-center (BDC) position, the piston having a diameter of less than 45 mm, and a stroke length of the piston between the TDC position and the BDC position measuring greater than 60 mm and less than 90 mm;
a driver blade attached to the piston for movement therewith along a driving axis from the TDC position toward the BDC position for driving a fastener into a workpiece, the driver blade including, a first end, a second end, and a plurality of drive teeth extending from one side between the first end and the second end;
a lifter operable to move the piston and driver blade from the BDC position toward the TDC position, wherein the lifter includes a body and a plurality of drive pins supported upon the body, wherein each of the drive pins is configured to engage one of the drive teeth, and wherein the drive pins are positioned on the body along an imaginary circle coaxial with a rotational axis of the lifter and having a diameter of less than 40 mm; and
a drive unit operably coupled to the lifter to provide torque thereto, causing the lifter to rotate.

2. The powered fastener driver of claim 1, further comprising a source of pressurized gas in fluid communication with the inner cylinder, wherein a striker force of the pressurized gas acting on the piston at the TDC position is greater than 200 lbf.

3. The powered fastener driver of claim 2, further comprising an outer storage chamber cylinder positioned within the housing and including the pressurized gas in fluid communication with the inner cylinder, wherein the outer storage chamber cylinder includes a first end and a second end opposite the first end, and wherein the second end of the outer storage chamber cylinder is non-concentric with the first end of the outer storage chamber cylinder.

4. The powered fastener driver of claim 3, wherein the inner cylinder includes a first end and a second end opposite a first end, and wherein the first end of the inner cylinder is coupled to the first end of the outer storage chamber cylinder.

5. The powered fastener driver of claim 4, wherein the outer storage chamber cylinder defines a volume, wherein a first portion of the volume is defined on a first side of the driving axis and a second portion of the volume is defined on a second side of the driving axis, and wherein the second portion is greater than the first portion.

6. The powered fastener driver of claim 5, wherein the housing defines a head portion, a drive unit housing portion, and a handle portion that is spaced apart from the drive unit housing portion, and wherein the second portion of the volume is at least partially positioned between the drive unit housing portion and the handle portion.

7. The powered fastener driver of claim 1, wherein, in response to continuous activation of the drive unit to rotate the lifter, the driver blade is configured to reciprocate between the TDC position and the BDC position at a frequency of at least 2 Hertz (Hz).

8. The powered fastener driver of claim 7, wherein the stroke length of the piston between the TDC position and the BDC position is 65 mm or greater while reciprocating at a frequency of at least 2 Hz.

9. The powered fastener driver of claim 8, wherein the drive unit is configured to remain continuously activated for over 100 seconds while reciprocating the driver blade at a frequency of at least 2 Hz.

10. The powered fastener driver of claim 1, wherein the piston includes a circumferential groove, wherein a seal ring is positioned within the circumferential groove, and wherein the seal ring has a thickness of 2 mm to 5.5 mm.

11. The powered fastener driver of claim 10, wherein the seal ring is a quad ring.

12. A powered fastener driver comprising:
a housing;
an inner cylinder within the housing;
a piston movable within the inner cylinder from a top-dead-center (TDC) position to a driven or bottom-dead-center (BDC) position, the piston having a circumferential groove, a diameter of less than 45 mm, and a stroke length of the piston between the TDC position and the BDC position measuring greater than 60 mm and less than 90 mm;
a seal ring positioned within the circumferential groove and configured to engage an inner surface of the inner cylinder, the seal ring having a thickness of 2 mm to 5.5 mm;
a driver blade attached to the piston for movement therewith along a driving axis from the TDC position toward the BDC position for driving a fastener into a workpiece, the driver blade including, a first end, a second end, and a plurality of drive teeth extending from one side between the first end and the second end;
a lifter operable to move the piston and driver blade from the BDC position toward the TDC position, wherein the lifter includes a body and a plurality of drive pins supported upon the body, wherein each of the drive pins is configured to engage one of the drive teeth; and
a drive unit operably coupled to the lifter to provide torque thereto, causing the lifter to rotate.

13. The powered fastener driver of claim 12, wherein the seal ring is a quad ring.

14. The powered fastener driver of claim 12, wherein the circumferential groove in the piston is a first circumferential groove, and wherein the piston further includes a second circumferential groove and a third circumferential groove, a first guide ring positioned in the second circumferential groove and a second guide ring positioned in the third circumferential groove, each of the first guide ring and the second guide ring are configured to engage the inner surface of the inner cylinder.

15. The powered fastener driver of claim 12, further comprising a source of pressurized gas in fluid communication with the inner cylinder, wherein a striker force of the pressurized gas acting on the piston at the TDC position is greater than 200 lbf.

16. A powered fastener driver comprising:
a housing;
an inner cylinder within the housing;
an outer storage chamber cylinder positioned within the housing and including pressurized gas in fluid communication with the inner cylinder, wherein the outer storage chamber cylinder includes a first end and a second end opposite the first end, and wherein the second end of the outer storage chamber cylinder is non-concentric with the first end of the outer storage chamber cylinder;
a piston movable within the inner cylinder from a top-dead-center (TDC) position to a driven or bottom-dead-center (BDC) position, the piston having a circumferential groove, a diameter of less than 45 mm, and a stroke length of the piston between the TDC position and the BDC position measuring greater than 60 mm and less than 90 mm;
a seal ring positioned within the circumferential groove and configured to engage an inner surface of the inner cylinder;
a driver blade attached to the piston for movement therewith along a driving axis from the TDC position toward the BDC position for driving a fastener into a workpiece, the driver blade including, a first end, a second end, and a plurality of teeth extending from one side between the first end and the second end;
a lifter operable to move the piston and driver blade from the BDC position toward the TDC position, wherein the lifter includes a body and a plurality of drive pins supported upon the body, wherein each of the drive pins is configured to engage one of the drive teeth; and
a drive unit operably coupled to the lifter to provide torque thereto, causing the lifter to rotate;
wherein the outer storage chamber cylinder defines a volume, wherein a first portion of the volume is defined on a first side of the driving axis and a second portion of the volume is defined on a second side of the driving axis, and wherein the second portion is greater than the first portion, and
wherein the housing defines a head portion, a drive unit housing portion, and a handle portion that is spaced apart from the drive unit housing portion, and wherein the second portion of the volume is at least partially positioned between the drive unit housing portion and the handle portion.

17. The powered fastener driver of claim 16, wherein the drive pins are positioned on the body along an imaginary circle coaxial with a rotational axis of the lifter and having a diameter of less than 40 mm.

18. The powered fastener driver of claim 17, further comprising a source of pressurized gas in fluid communication with the inner cylinder, wherein a striker force of the pressurized gas acting on the piston at the TDC position is greater than 200 lbf.

19. The powered fastener driver of claim 16, wherein the inner cylinder includes a first end and a second end opposite a first end, and wherein the first end of the inner cylinder is coupled to the first end of the outer storage chamber cylinder.

20. The powered fastener driver of claim 16, wherein the circumferential groove in the piston is a first circumferential groove, and wherein the piston further includes a second circumferential groove and a third circumferential groove, a first guide ring positioned in the second circumferential groove and a second guide ring positioned in the third circumferential groove, each of the first guide ring and the second guide ring are configured to engage the inner surface of the inner cylinder.
